(19) United States
(12) Patent Application Publication
(10) Pub. No.: US 2020/0135374 A1
(43) Pub. Date: Apr. 30, 2020

(54) COIL COMPONENT AND MANUFACTURING METHOD OF COIL COMPONENT

(71) Applicant: SAMSUNG ELECTRO-MECHANICS CO., LTD., Suwon-si (KR)

(72) Inventors: Dae Hyung You, Suwon-si (KR); Jong Min Lee, Suwon-si (KR)

(21) Appl. No.: 16/573,331

(22) Filed: Sep. 17, 2019

(30) Foreign Application Priority Data
Oct. 31, 2018 (KR) 10-2018-0131682

(51) Int. Cl. H01F 17/00; H01F 27/28; H01F 27/29; H01F 41/04; H01F 17/04

(52) U.S. Cl. CPC H01F 17/0013; H01F 27/2804; H01F 27/292; H01F 41/04; H01F 2017/0073; H01F 27/2852; H01F 2017/048; H01F 2027/2809; H01F 17/04

(57) ABSTRACT

A coil component includes a body, a coil portion embedded in the body, and an insulating substrate embedded in the body, and having a support member supporting the coil portion, and first and second connection portions extending from the support member to opposing side surfaces of the body, respectively, and each of the first and second connection portions includes a pair of connection portions spaced apart from each other.

CROSS-REFERENCE TO RELATED APPLICATION(S)

This application claims the benefit of priority to Korean Patent Application No. 10-2018-0131682 filed on Oct. 31, 2018 in the Korean Intellectual Property Office, the entire disclosure of which is incorporated herein by reference.

### TECHNICAL FIELD

The present disclosure relates to a coil component and a method of manufacturing the coil component.

### BACKGROUND

An inductor, a coil component, is a typical passive electronic component used in an electronic device, along with a resistor and a capacitor.

As electronic devices have been implemented with increasingly higher levels of performance and have become ever smaller, the number of electronic components used in electronic devices has been increasing and electronic components have been reduced in size.

### SUMMARY

An aspect of the present disclosure is to provide a coil component capable of preventing a coil portion from being deformed in a process in which a magnetic composite sheet is stacked and pressed, and a method of manufacturing a coil component.

Another aspect of the present disclosure is to provide a coil component capable of reducing a defect rate caused by deformation of a coil portion while having a low-profile, and a method of manufacturing the coil component.

According to an aspect of the present disclosure, a coil component includes: a body; a coil portion embedded in the body; and an insulating substrate embedded in the body, and having a support member supporting the coil portion, and first and second connection portions extending from the support member to opposing side surfaces of the body, respectively, and each of the first and second connection portions includes a pair of connection portions spaced apart from each other.

According to another aspect of the present disclosure, a coil component includes: a body; a coil portion embedded in the body; and an insulating substrate embedded in the body, and having a support member supporting the coil portion, wherein the insulating substrate further includes: a pair of first connection portions, spaced apart from each other, protruding from the support member and exposed to one side surface of the body; and a pair of second connection portions, spaced apart from each other, protruding from the support member and exposed to another side surface of the body opposing the one side surface of the body.

Other features and aspects will be apparent from the following detailed description, the drawings, and the claims.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view of a coil component according to an exemplary embodiment of the present disclosure;

FIG. 2 is a schematic plan view illustrating a coil component according to an exemplary embodiment of the present disclosure;

FIG. 3 is a cross-sectional view taken along line I-I′ of FIG. 1;

FIG. 4 is a cross-sectional view taken along line II-II′ of FIG. 1; and

FIGS. 5 to 7 are views sequentially illustrating a method of manufacturing a coil component according to an exemplary embodiment of the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

In the drawings, the L direction may be defined as a first direction or a longitudinal direction, the W direction may be defined as a second direction or a width direction, and the T direction may be defined as a third direction or a thickness direction.

Hereinafter, a coil component according to an exemplary embodiment of the present disclosure will be described in detail with reference to the accompanying drawings. Referring to the accompanying drawings, the same or corresponding components are denoted by the same reference numerals, and a duplicate description thereof will be omitted.

Various types of electronic components are used in electronic devices. Here, various types of coil components may be suitably used for the purpose of noise removal or the like among these electronic components.

In other words, a coil component in an electronic device may be used as a power inductor, a high frequency (HF) inductor, a general bead, a GHz bead, a common mode filter, or the like.

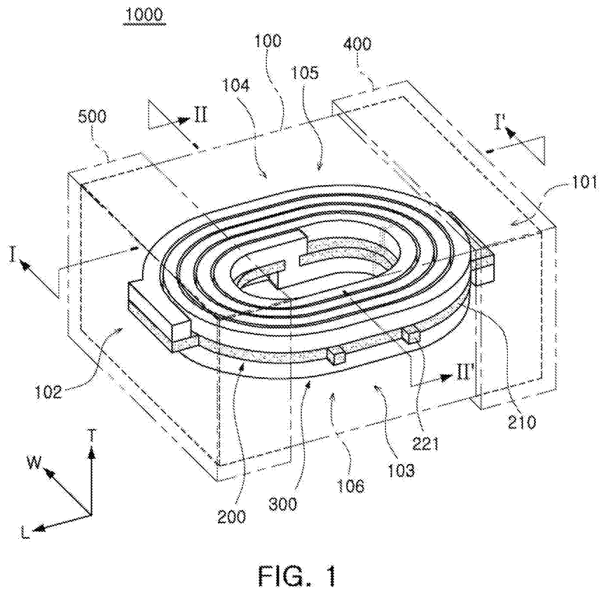

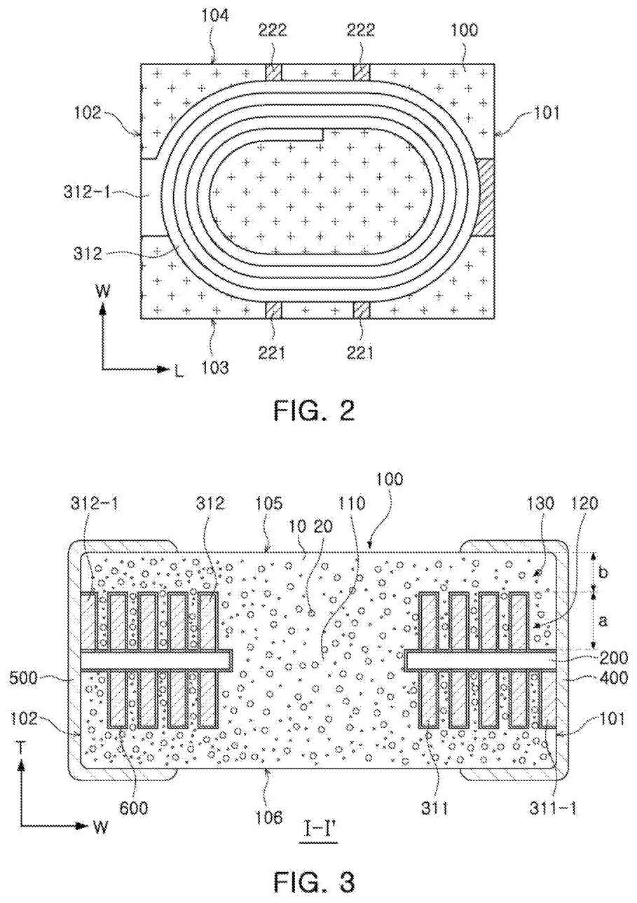

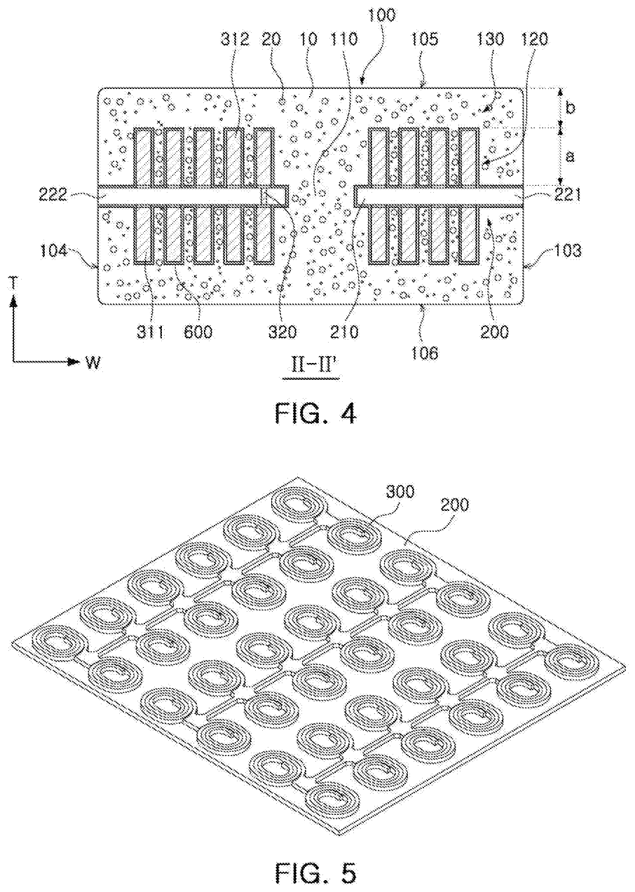

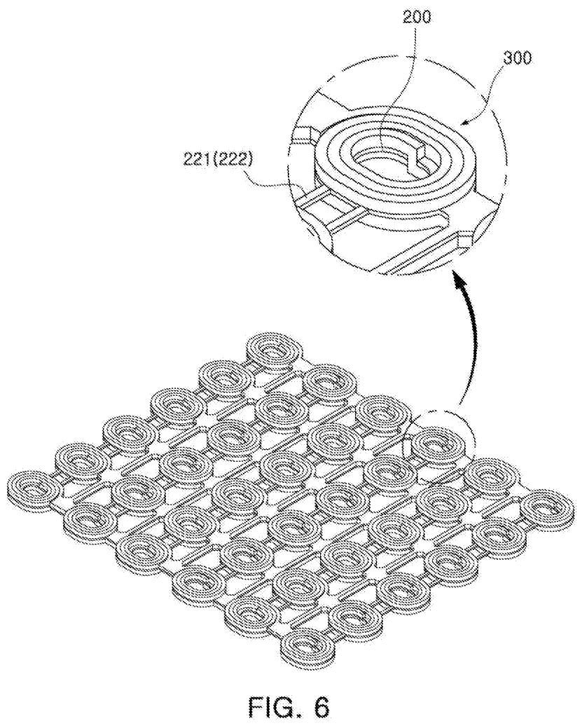

FIG. 1 is a schematic perspective view of a coil component according to an exemplary embodiment of the present disclosure. FIG. 2 is a schematic plan view illustrating a coil component according to an exemplary embodiment of the present disclosure. FIG. 3 is a cross-sectional view taken along line I-I′ of FIG. 1. FIG. 4 is a cross-sectional view taken along line II-II′ of FIG. 1.

Referring to FIGS. 1 to 4, a coil component 1000 according to an exemplary embodiment of the present disclosure includes a body 100, an insulating substrate 200, a coil portion 300, and external electrodes 400 and 500, and may further include an insulating film 600.

The body 100 forms an exterior of the coil component 1000 according to an exemplary embodiment of the present disclosure, and the insulating substrate 200 and the coil portion 300 are embedded therein.

The body 100 may be hexahedral as a whole.

Based on FIGS. 1 and 4, the body 100 includes a first surface 101 and a second surface 102 opposing each other in a longitudinal direction L, a third surface 103 and a fourth surface 104 opposing each other in a width direction W, and a fifth surface 105 and a sixth surface 106 opposing each other in a thickness direction T. Each of the first to fourth sides 101, 102, 103, and 104 of the body 100 may correspond to a wall of the body 100, connecting the fifth surface 105 to the sixth surface 106 of the body 100. Hereinafter, both end surfaces of the body 100 refer to the first surface 101 and the second surface 102 of the body 100, both side surfaces of the body 100 refer to the third surface 103 and the fourth surface 104 of the body 100, one surface of the body 100 refers to the sixth surface 106 of the body 100, and the other surface of the body 100 refers to the fifth surface 105 of the body 100.

The body 100 may be formed to allow the coil component 1000 having external electrodes 400 and 500 to be described later, according to an exemplary embodiment of the present disclosure, to have a length of 2.0 mm, a width of 1.2 mm, and a thickness of 0.65 mm, by way of example, but is not limited thereto. As another example, in the body 100, the coil component 1000 according to an exemplary embodiment of the present disclosure may be formed to have a length of 2.0 mm, a width of 1.6 mm, and a thickness of 0.55 mm, or to have a length of 2.0 mm, a width of 1.2 mm, and a thickness of 0.55 mm, or to have a length of 1.2 mm, a width of 1.0 mm, and a thickness of 0.55 mm. Meanwhile, as will be described later, as the coil component 1000 has a low-profile, heat and pressure, applied to the insulating substrate 200 and the coil portion 300, may be increased in a process of forming the body 100. Accordingly, the first and second connection portions 221 and 222, applied to an exemplary embodiment of the present disclosure, may be applied to the case of the coil component having a thickness less than the thickness described above. Thus, the range of an exemplary embodiment of the present disclosure is not limited to a thickness of a coil component, and may be applied to the case in which the coil component is formed to have a thickness less than the thickness described above.

The body 100 may include a magnetic material and an insulating resin 10. In detail, the body 100 may be formed by stacking one or more magnetic composite sheets (30 of FIG. 7) including the insulating resin 10 and a magnetic material dispersed in the insulating resin 10. However, the body 100 may have a structure different from the structure in which a magnetic material is dispersed in the insulating resin 10. For example, the body 100 may be formed of a magnetic material such as ferrite.

The magnetic material may be a magnetic powder 20, and may be ferrite or metal magnetic powder, by way of example.

The ferrite powder may be, for example, at least one or more among spinel type ferrite such as Mg—Zn-based, Mn—Zn-based, Mn—Mg-based, Cu—Zn-based, Mg—Mn—Sr-based, Ni—Zn-based ferrite, or the like, hexagonal ferrite such as Ba—Zn-based, Ba—Mg-based, Ba—Ni-based, Ba—Co-based, Ba—Ni-Co-based ferrite, or the like, garnet type ferrite such as Y-based ferrite, or the like, and Li-based ferrite.

The metal magnetic powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be at least one or more among pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, and Fe—Cr—Al-based alloy powder.

The metal magnetic powder may be amorphous or crystalline. For example, the metal magnetic powder may be Fe—Si—B—Cr-based amorphous alloy powder, but is not limited thereto.

Each particle of the ferrite and the metal magnetic powder may have an average diameter of about 0.1 μm to 30 μm, but is not limited thereto.

The body 100 may include two or more types of magnetic powder 20 dispersed in an insulating resin. Here, the different types of magnetic powder 20 mean that the two or more types of magnetic powder 20, dispersed in the insulating resin 10, are distinguished from each other by any one of an average diameter, a composition, crystallinity, and a shape of particles thereof. For example, the body 100 may include two or more types of magnetic powder 20 having different average particle diameters from each other.

The insulating resin 10 may include one among epoxy, polyimide, a liquid crystal polymer, or a mixture thereof, but is not limited thereto.

The body 100 includes a core 110 passing through a coil portion 300 to be described later. The core 110 may be formed by filling a through hole of the coil portion 300 with the magnetic composite sheet (30 of FIG. 7), but is not limited thereto.

The body 100 may have an active portion 120 and a cover portion 130, disposed on the active portion 120. The active portion 120 refers to one region in which the coil component 1000 according to an exemplary embodiment of the present disclosure exhibits a substantial function due to the coil portion 300 of the body 100, while the cover portion 130 refers to the other region assisting a function of the active portion 120 of the body 100. By way of example only and without limitations, based on directions of FIGS. 3 and 4, the active portion 120 and the cover portion 130 may refer to a region, in which the second coil pattern 312 of the coil portion 300 is disposed, and a region disposed thereon, respectively, based on a region of the body 100, disposed in an upper portion of the insulating substrate 200. As another example, the active portion 120 may be defined as one region of the body 100, corresponding to the sum of a thickness of the insulating substrate 200 of thicknesses of the first and second coil patterns 311 and 312, while the cover portion 130 may be defined as the other region of the body 100, disposed on the first and second coil patterns 311 and 312. Hereinafter, the active portion 120 and the cover portion 130, applied to the present disclosure, will be described in the sense of the former.

A thickness of the active portion 120 is formed to be greater than a thickness b of the cover portion 130. Thus, the coil component 1000 according to an exemplary embodiment of the present disclosure may secure a thickness of a region for exhibiting a substantial function, while a thickness of an entirety of the coil component 1000 may be reduced, that is, may have a low-profile. By way of example only and without limitations, the active portion 120 may be formed to have magnetic permeability greater than magnetic permeability of the cover portion 130. To this end, magnetic powder of the active portion 120 may have magnetic permeability greater than that of magnetic powder of the cover portion 130. Alternatively or concurrently, a filling rate of magnetic powder of the active portion 120 may be greater than a filling rate of magnetic powder of the cover portion 130.

The insulating substrate 200 may be embedded in the body 100. The insulating substrate 200 may be provided as a component supporting a coil portion 300 to be described later.

The insulating substrate 200 may be formed as an insulating material including a thermosetting resin such as an epoxy resin, a thermoplastic resin such as a polyimide, or a photosensitive insulating resin, or may be formed as an insulating resin in which a stiffener such as a glass fiber or an inorganic filler is impregnated. As an example, the insulating substrate 200 may be formed of an insulating material such as prepreg, an Ajinomoto build-up film (ABF), an FR-4, a bismaleimide triazine (BT) film, a photo imagable dielectric (PID) film, but is not limited thereto.

The inorganic filler may be one or more selected from the group consisting of silica (SiO₂), alumina (Al₂O₃), silicon carbide (SiC), barium sulphate (BaSO₄), talc, mud, mica powder, aluminum hydroxide (AlOH₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the insulating substrate 200 is formed of an insulating material including a stiffener, the insulating substrate 200 may provide more excellent stiffness. When the insulating substrate 200 is formed of an insulating material not including a glass fiber, the insulating substrate 200 is advantageous for reducing a thickness of the entirety of the coil portion 300, that is, having a low-profile. When the insulating substrate 200 is formed of an insulating material including a photosensitive insulating resin, the number of processes for formation of the coil portion 300 is reduced, so it is advantageous to reduce production costs, and fine via can be formed.

The insulating substrate 200 includes a support member 210 supporting a coil portion 300, to be described later, and first and second connection portions 221 and 222, extended from the support member 210 to third and fourth surfaces 103 and 104 of the body 100, opposing each other,.

The support member 210 is a member supporting first and second coil patterns 311 and 312, and ends 311-1 and 312-1 of the first and second coil patterns 311 and 312, of the coil portion 300, and may be formed to have a shape corresponding to a shape of the first and second coil patterns 311 and 312, and the ends 311-1 and 312-1 of the first and second coil patterns 311 and 312. The first and second connection portions 221 and 222 may prevent each unit coil portion 300 from being deformed by connecting adjacent unit coil portions 300 to each other, when staking the magnetic composite sheets (30 of FIG. 7), as will be described later. The first and second connection portions 221 and 222 are formed to have a form for connecting unit support members 210, supporting adjacent unit coil portions 300, and then separated through an operation of individualizing the unit coil portion 300 to be exposed to the third and fourth surfaces 103 and 104 of the body 100 of each unit coil component 1000, respectively.

According to an exemplary embodiment of the present disclosure, each of the first and second connection portions 221 and 222 is provided as a pair of connection portions, spaced apart from each other. In other words, as illustrated in FIGS. 1, 2, and 4, the first connection portion 221 is extended from the support member 210 of the insulating substrate 200, each end surface is exposed to the third surface 103 of the body 100, and the first connection portion is provided as a pair of first connection portions spaced apart from each other. The second connection portion 222 is extended from the support member 210, each end surface is exposed to the fourth surface 104 of the body 100, and the second connection portion is provided as a pair of second connection portions spaced apart from each other. As the coil component 1000 has a low-profile, during formation of the body 100 of the coil component 1000, a pressure and a temperature, applied thereto, are increased. In this case, the possibility of deformation of the coil part 300 may be increased. According to an exemplary embodiment of the present disclosure, each of the first and second connection portions 221 and 222 is provided as a pair of connection portions, spaced apart from each other. Thus, during formation of the body 100, stress, applied to the coil portion 300 and the insulating substrate 200, may be reduced. That is, as an example, a portion of the magnetic composite sheet (30 of FIG. 7) for formation of the body 100 may flow into a space between a pair of first connection portions 221, spaced apart from each other, so deformation of the insulating substrate 200 may be significantly reduced. Thus, deformation of the coil portion 300, disposed on the insulating substrate 200, may be significantly reduced.

The first and second connection portions 221 and 222 may be formed symmetrically with respect to each other. Here, the ‘formed symmetrically’ is a concept including point symmetry and line symmetry. By way of example only and without limitations, a separation distance between a pair of first connection portions 221 may correspond to a separation distance between a pair of second connection portions 222. As another example, the first connection portion 221 disposed on the left side and the second connection portion 222 disposed on the left side with respect to a direction of FIG. 2 may be positioned together on one line segment parallel to a width direction W of the body 100, while the first connection portion 221 disposed on the right side and the second connection portion 222 disposed on the right side with respect to the direction of FIG. 2 may be positioned together on the other line segment parallel to the width direction W of the body 100. In the case of the former and the latter, during the formation of the body 100, stress, applied to the insulating substrate 200 and the coil portion 300, is relatively evenly distributed in the width direction W of the body 100, so deformation of the coil portion 300 may be significantly reduced.

The coil portion 300 is embedded in the body 100, thereby having characteristics of a coil component. For example, when the coil component 1000 according to an exemplary embodiment of the present disclosure is used as a power inductor, the coil portion 300 may function to stabilize the power of an electronic device by storing an electric field as a magnetic field and maintaining an output voltage.

The coil portion 300 includes coil patterns 311 and 312, as well as a via 320. In detail, with reference to directions of FIGS. 1, 3, and 4, the first coil pattern 311 and an end 311-1 of the first coil pattern 311 are disposed on a lower surface of the insulating substrate 200, opposing a sixth surface 106 of the body 100, while the second coil pattern 312 and an end 312-1 of the second coil pattern 312 are disposed on an upper surface of the insulating substrate 200. The via 320 passes through the insulating substrate 200 to be in contact with each of the first coil pattern 311 and the second coil pattern 312. Therethrough, the coil portion 300 may function as a single coil forming one or more turns about the core 110 as a whole.

Each of the first coil pattern 311 and the second coil pattern 312 may have a planar and spiral shape forming at least one turn around the core 110 provided as an axis.

As an example, the first coil pattern 311 may form at least one turn around the core 110, provided as an axis, in a lower portion of the insulating substrate 200.

At least one among the via 320 and the coil patterns 311 and 312 may include one or more conductive layers. As an example, when the second coil pattern 312, the end 312-1 of the second coil pattern 312, and the via 320 are formed on the other side of the insulating substrate 200 by plating, each of the second coil pattern 312, the end 312-1 of the second coil pattern 312, and the via 320 may include a seed layer such as an electroless plating layer, or the like, and an electroplating layer. Here, the electroplating layer may have a monolayer structure, and may have a multilayer structure. The electroplating layer with a multilayer structure may have a conformal film structure in which one electroplating layer is covered by the other electroplating layer, and may have a form in which one electroplating layer is only stacked on one side of the other electroplating layer. A seed layer of the second coil pattern 312, a seed layer of the end 312-1 of the second coil pattern 312, and a seed layer of the via 320 are integrally formed, so boundaries therebetween may not be formed, but an embodiment is not limited thereto. An electroplating layer of the second coil pattern 312, the electroplating layer of the end 312-1 of the second coil pattern 312, and the electroplating layer of the via 320 are integrally formed, so boundaries therebetween may not be formed, but an embodiment is not limited thereto.

As another example, with respect to directions of FIGS. 1, 3, and 4, a first coil pattern 311, disposed in a lower surface of the insulating substrate 200, and the end 311-1 thereof, and a second coil pattern 312, disposed in an upper surface of the insulating substrate 200, and the end 312-1 thereof, are provided separately from each other, and are then batch-stacked on the insulating substrate 200 to form the coil portion 300. In this case, the via 320 may include a high melting point metal layer and a low melting point metal layer having a melting point, lower than a melting point of the high melting point metal layer. Here, the low melting point metal layer may be formed of a solder including lead (Pb) and/or tin (Sn). At least a portion of the low melting point metal layer is melted due to the pressure and temperature during the batch stack, so an inter metallic compound (IMC) layer may be formed at a boundary between the low melting point metal layer and the second coil pattern 312, by way of example.

Based on directions of FIGS. 3 and 4, the coil patterns 311 and 312 and the ends 311-1 and 312-1 thereof may be protruding from a lower surface and an upper surface of the insulating substrate 200, respectively. As another example, the first coil pattern 311 and the end 311-1 thereof are protruding from a lower surface of the insulating substrate 200, while the second coil pattern 312 and the end 312-1 thereof are embedded in an upper surface of the insulating substrate 200. Thus, an upper surface of each of the second coil pattern 312 and the end 312-1 thereof may be exposed to an upper surface of the insulating substrate 200. In this case, a concave portion is formed in an upper surface of the second coil pattern 312 and/or the end 312-1 of the second coil pattern 312. Thus, an upper surface of the second coil pattern 312 and/or the end 312-1 of the second coil pattern 312 and an upper surface of the insulating substrate 200 may not be located on the same plane. As another example, the second coil pattern 312 and the end 312-1 thereof are protruding from an upper surface of the insulating substrate 200, while the first coil pattern 311 and the end 311-1 thereof are embedded in a lower surface of the insulating substrate 200. Thus, a lower surface of each of the first coil pattern 311 and the end 311-1 thereof may be exposed to a lower surface of the insulating substrate 200. In this case, a concave portion is formed in a lower surface of the first coil pattern 311 and/or leading-out patterns 331 and 332. Thus, a lower surface of the first coil pattern 311 and/or the end 311-1 of the first coil pattern 311 and a lower surface of the insulating substrate 200 may not be located on the same plane.

Each of the via 320 and the coil patterns 311 and 312 may include a conductive material such as copper (Cu), aluminum (Al), silver (Ag), tin (Sn), gold (Au), nickel (Ni), lead (Pb), titanium (Ti), or alloys thereof, but are not limited thereto.

The external electrodes 400 and 500 are disposed on a surface of the body 100 to be connected to both ends 311-1 and 312-1 of the coil portion 300, respectively. According to an exemplary embodiment of the present disclosure, both ends 311-1 and 312-1 of the coil portion 300 are exposed to the first and second surfaces 101 and 102 of the body 100, respectively. Thus, the first external electrode 400 is disposed on the first surface 101 to be in contact with and connected to an end 311-1 of the first coil pattern 311, exposed to the first surface 101 of the body 101, while the second external electrode 500 is disposed on the second surface 102 to be in contact with and connected to an end 312-1 of the second coil pattern 312, exposed to the second surface 102 of the body 100.

The external electrodes 400 and 500 may be formed as a single layer or a plurality of layers. As an example, the first external electrode 400 may be composed of a first layer containing copper, a second layer disposed on the first layer and containing nickel (Ni), and a third layer disposed on the second layer and containing tin (Sn). Here, each of the first to third layer may be formed by plating, but is not limited thereto. As another example, the first external electrode 400 may include a resin electrode including conductive powder and a resin, and a plating layer formed on the resin electrode by plating.

The external electrodes 400 and 500 may include a conductive material such as copper (Cu), aluminum (Al), silver (Ag), tin (Sn), gold (Au), nickel (Ni), lead (Pb), titanium (Ti), or alloys thereof, but are not limited thereto.

The insulating film 600 may be formed in the insulating substrate 200 and the coil portion 300. The insulating film 600 is provided for insulating the coil portion 300 from the body 100, and may include a known insulating material such as parylene. Any insulating material may be used for the insulating material included in the insulating film 600, and there is no particular limitation. The insulating film 600 may be formed using a method such as vapor deposition, or the like, but is not limited thereto. Alternatively, the insulating film may be formed by stacking an insulating film on each of both sides of the insulating substrate 200. In the case of the former, the insulating film 600 may have a form of a conformal film along a surface of the insulating substrate 200 and the coil portion 300. Meanwhile, according to an exemplary embodiment of the present disclosure, the insulating film 600 is an optional configuration. When sufficient insulation resistance can be secured in the body 100 at an operating voltage and an operating current of the coil component 1000 according to an exemplary embodiment of the present disclosure, the insulating film 600 may be omitted.

In this regard, in the coil component 1000 according to an exemplary embodiment of the present disclosure, the connection portions 221 and 222 are formed in the insulating substrate 200, so deformation of the insulating substrate 200 and the coil portion 300, which may occur during a manufacturing process, may be significantly reduced.

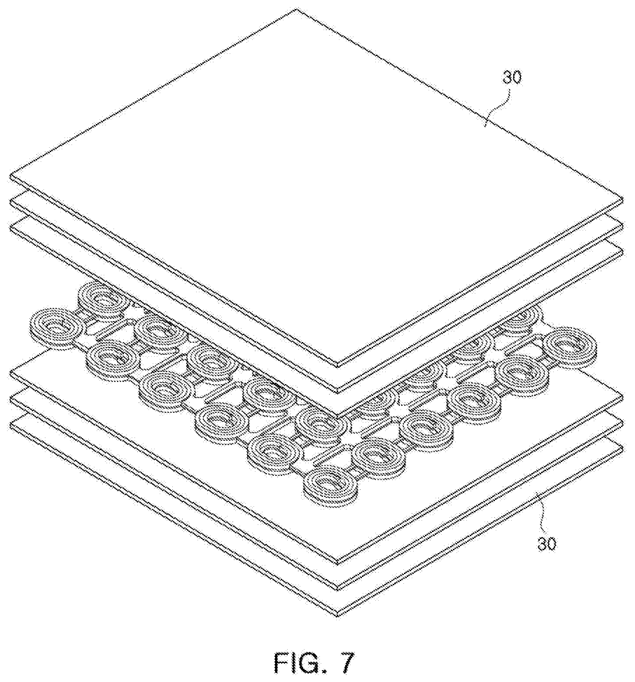

FIGS. 5 to 7 are views sequentially illustrating a method of manufacturing a coil component according to an exemplary embodiment of the present disclosure.

Referring to FIGS. 5 to 7, a method of manufacturing a coil component according to an exemplary embodiment of the present disclosure includes: forming a plurality of coil portions in an insulating substrate; removing a portion in which the plurality of coil portions are not formed from the insulating substrate; forming a body by stacking a magnetic composite sheet including an insulating resin and magnetic powder on the insulating substrate; and forming first and second external electrodes on a surface of the body. The removing the portion in which the plurality of coil portions are not formed from the insulating substrate includes: connecting a support member, supporting the plurality of coil portions, to the adjacent support member, and forming first and second connection portions in the insulating substrate, each of the first and second connection portions being provided as a pair of connection portions.

First, referring to FIG. 5, a plurality of coil portions 300 are formed in an insulating substrate 200.

The insulating substrate 200 is not particularly, may be at least one among a copper clad laminate, PrePreG (PPG), an Ajinomoto build-up film (ABF), and a photo imageable dielectric (PID), and may have a thickness of 20 μm to 100 μm.

A formation method of the coil portion 300 may be an electroplating method, by way of example, but is not limited thereto. Alternatively, the coil portion 300 may be formed by including a metal having excellent electrical conductivity, and may be formed using silver (Ag), palladium (Pd), aluminum (Al), nickel (Ni), titanium (Ti), gold (Au), copper (Cu), platinum (Pt), or alloys thereof.

A via hole is formed in a portion of the insulating substrate 200, and is filled with a conductive material to form a via 320. Moreover, through the via 320, the coil patterns 311 and 312, formed in one side and the other side of the insulating substrate 200, may be electrically connected to each other.

The coil portion 300 may include both ends 311-1 and 312-1, exposed to first and second surfaces 101 and 102 of the body 100, respectively, after dicing. In a coil substrate condition before dicing, both ends of the unit coil portion 300, adjacent to each other, may be physically and electrically connected to each other.

Referring to FIG. 6, a portion, in which a coil portion 300 is not formed, may be removed from an insulating substrate 200.

Removal of the insulating substrate 200 may be performed by applying mechanical drilling, laser drilling, sand blast, or a punching process, for example, a CO₂ laser drill.

A central region of the insulating substrate 200, in which the coil portion 300 is not formed, is removed to form a through hole passing through an insulating substrate 200.

In this case, a portion of the insulating substrate 200, in which the coil portion 300 is not formed, is removed, except for some, so the first and second connection portions 221 and 222 are provided. The remaining portion, not removed from the insulating substrate 200, of each of the first and second connection portions 221 and 222, may be provided as a pair of connection portions, spaced apart from each other.

In the related art, an insulating substrate 200 in all regions, except a portion with the coil portion 300 formed therein, is removed. However, according to an exemplary embodiment of the present disclosure, while an insulating substrate 200 in a portion of a region in which a coil portion 300 is not formed is not removed, first and second connection portions 221, 222 are formed, so a force for supporting the coil portion 300 is increased. Thus, when magnetic composite sheets are stacked and pressed, deformation of the coil portion 300 may be significantly reduced.

An insulating film 600, covering the coil portion 300, may be formed on a surface of the coil portion 300. The insulating film 600 may be formed using a method, for example, a screen printing method, a spray coating process, a vacuum dipping process, a vapor deposition process, such as a chemical vapor deposition (CVD), a film lamination process, or the like, but is not limited thereto.

Referring to FIG. 7, a magnetic composite sheet 30 is stacked on an insulating substrate 200 with a coil portion 300 formed therein to form a body 100.

The magnetic composite sheets 30 are stacked on both sides of the insulating substrate 200 and pressed through a laminating method or a hydrostatic pressing method to form the body 100.

In this case, a through hole formed in a central portion of the insulating substrate 200 is filled with at least a portion of the magnetic composite sheet 30, so a core 110 may be provided.

Meanwhile, although not illustrated, after the operation described above, a dicing process of individualizing a plurality of coil portions 300 may be included, and first and second external electrodes 400 and 500 may be formed on a surface of the individualized body 100. In the dicing process, the connection portions 221 and 222, connecting support members 210 of a plurality of coil portions 300, adjacent to each other, are cut by a dicing tip, to be exposed to the third and fourth surfaces 103 and 104 of the body 100.

As set forth above, according to an exemplary embodiment in the present disclosure, a coil portion may be prevented from being deformed in a process in which a magnetic composite sheet is stacked and pressed.

While a coil component has a low-profile, a defect rate due to deformation of a coil portion may be reduced.

While exemplary embodiments have been shown and described above, it will be apparent to those skilled in the art that modifications and variations could be made without departing from the scope of the present invention as defined by the appended claims.

What is claimed is:

1. A coil component, comprising:
a body;
a coil portion embedded in the body; and
an insulating substrate embedded in the body, and including a support member supporting the coil portion, and first and second connection portions extending from the support member to opposing side surfaces of the body, respectively,
wherein each of the first and second connection portions includes a pair of connection portions spaced apart from each other.

2. The coil component of claim 1, wherein the body has an active portion with the coil portion disposed therein, and a cover portion disposed on the active portion, and
a thickness of the active portion is greater than a thickness of the cover portion.

3. The coil component of claim 1, wherein the first connection portion includes a pair of first connection portions and the second connection portion includes a pair of second connection portions, and
a separation distance between the pair of first connection portions is equal to a separation distance between the pair of second connection portions.

4. The coil component of claim 1, wherein both ends of the coil portion are respectively exposed to opposing end surfaces of the body connecting the opposing side surfaces of the body to each other.

5. The coil component of claim 1, wherein the first and second connection portions are symmetrical to each other.

6. The coil component of claim 1, wherein the coil portion includes:
a first coil pattern having a planar and spiral shape and disposed on one side of the insulating substrate;
a second coil pattern having a planar and spiral shape and disposed on another side of the insulating substrate opposing the one side of the insulating substrate; and
a via penetrating through the insulating substrate to connect the first coil pattern to the second coil pattern.

7. The coil component of claim 6, wherein the body has a first cover portion defined as a portion of the body disposed above the first coil pattern and a second cover portion defined as a portion of the body disposed below the first coil pattern, and
thicknesses of the first and second coil patterns are greater than thicknesses of the first and second cover portions, respectively.

8. The coil component of claim 1, wherein the body includes an insulating resin and magnetic powder.

9. The coil component of claim 1, further comprising:
first and second external electrodes disposed on the body, and connected to both ends of the coil portion, respectively.

10. The coil component of claim 1, wherein an insulating film is disposed on an exterior of the insulating substrate and an exterior of the coil portion.

11. The coil component of claim 1, wherein the first and second connection portions do not overlap the coil portion in a stacking direction of the coil portion and the insulting substrate.

12. A method for manufacturing a coil component, comprising:
forming a plurality of coil portions on an insulating substrate;
removing a portion of the insulating substrate, on which the plurality of coil portions are not formed;
forming a body by stacking a magnetic composite sheet, including an insulating resin and magnetic powder, on the insulating substrate; and
forming first and second external electrodes on a surface of the body,
wherein the removing a portion of the insulating substrate includes forming first and second connection portions, each of the first and second connection portions including a pair of connection portions in the insulating substrate.

13. A coil component, comprising:
a body;
a coil portion embedded in the body; and
an insulating substrate embedded in the body, and including a support member supporting the coil portion,
wherein the insulating substrate further includes:
a pair of first connection portions, spaced apart from each other, protruding from the support member and exposed to one side surface of the body; and a pair of second connection portions, spaced apart from each other, protruding from the support member and exposed to another side surface of the body opposing the one side surface of the body.

14. The coil component of claim 13, wherein the body has an active portion with the coil portion disposed therein, and a cover portion disposed on the active portion, and
a thickness of the active portion is greater than a thickness of the cover portion.

15. The coil component of claim 13, wherein a separation distance between the pair of first connection portions is equal to a separation distance between the pair of second connection portions.

16. The coil component of claim 13, wherein both ends of the coil portion are respectively exposed to opposing end surfaces of the body connecting the opposing side surfaces of the body to each other.

17. The coil component of claim 13, wherein the pair of first connection portions and the pair of second connection portions are symmetrical to each other.

18. The coil component of claim 13, wherein the coil portion includes:
a first coil pattern having a planar and spiral shape and disposed on one side of the insulating substrate;
a second coil pattern having a planar and spiral shape and disposed on another side of the insulating substrate opposing the one side of the insulating substrate; and
a via penetrating through the insulating substrate to connect the first coil pattern to the second coil pattern.

19. The coil component of claim 18, wherein the body has a first cover portion defined as a portion of the body disposed above the first coil pattern and a second cover portion defined as a portion of the body disposed below the first coil pattern, and
thicknesses of the first and second coil patterns are greater than thicknesses of the first and second cover portions, respectively.

20. The coil component of claim 13, wherein the pair of first connection portions and the pair of second connection portions do not overlap the coil portion in a stacking direction of the coil portion and the insulting substrate.
